(19) United States
(12) Patent Application Publication
(10) Pub. No.: US 2026/0146913 A1
(43) Pub. Date: May 28, 2026

(54) ARRAYED HIGH-ENERGY LASER COUNTER-UAV TEST METHOD AND APPARATUS

(71) Applicant: Jiangxi Flight University, Nanchang (CN)

(72) Inventors: Wei Hu, Jingzhou (CN); Xuefeng Hu, Guanghan (CN); Shaopeng Li, Nanchang (CN); Yong Liu, Nanchang (CN); Jing Huang, Nanchang (CN); Congren Lu, Nanchang (CN); Feizhou Chen, Nanchang (CN)

(21) Appl. No.: 19/377,405

(22) Filed: Nov. 3, 2025

(30) Foreign Application Priority Data
Nov. 26, 2024 (CN) 202411698939.X

(51) Int. Cl. G01M 11/08; F41H 13/00; G01M 17/00; H01S 3/04

(52) U.S. Cl. CPC G01M 11/081; F41H 13/0062; G01M 17/00; H01S 3/0407

(57) ABSTRACT

An arrayed high-energy laser counter-UAV (unmanned aerial vehicle) test method and apparatus are provided, relating to the technical field of UAV tests. The method includes the following steps: preparing a test apparatus and a UAV; conducting a laser counter-UAV test; observing an ablation process and analyzing an ablated morphology of the UAV to obtain a radius and ablation depth of a tested ablation area of the UAV; performing finite element simulation on a test process to obtain a radius and ablation depth of a simulated ablation area of the UAV; and comparing the radii and ablation depths of the simulated and tested ablation areas of the UAV, adjusting finite element simulation parameters to make a simulation result coincide with a test result, and deriving an ablation depth-time variation curve of a key point in the simulated ablation area.

### TECHNICAL FIELD

The present disclosure relates to the technical field of UAV (Unmanned Aerial Vehicle) tests, and in particular to an arrayed high-energy laser counter-UAV test method and apparatus.

### BACKGROUND

In recent years, counter measures of UAVs have become an important issue in academia and engineering. High-power laser weapon, due to its advantages of low cost and rapid strike, has been paid more and more attention in the field of UAV countermeasures. When high-energy laser is used for ablating a UAV structure, the laser needs to reach a certain energy density per unit area to achieve the purpose of ablation.

Based on the requirements of long-range target tracking, laser weapons need to be combined with a radar or optical image tracking device, and a target point determined by tracking is generally a strike center point of high-energy laser. Although an image recognition system can perform target tracking on UAV, poor imaging clarity may be caused when facing a small UAV with a long distance. In addition, when a single-beam laser design solution is adopted, due to poor image tracking clarity, it is difficult for the single-beam laser to strike a specific part of the UAV accurately, which easily leads to inaccurate striking. To make up for the shortage of the image tracking device, it is necessary to develop laser devices with a wider range of strike. The arrayed high-energy laser composed of multiple high-energy laser devices can solve the problem of inaccurate strike, but the more the high-energy laser devices, the higher the cost. Therefore, it is necessary to analyze the mechanism of arrayed high-energy laser striking a UAV through experiments to optimize the structure of the arrayed high-energy laser, ensuring striking efficiency while reducing cost.

Therefore, it is necessary to design an arrayed high-energy laser counter-UAV test method.

### SUMMARY

An objective of the present disclosure is to at least solve one of the technical problems in the prior art and to provide an arrayed high-energy laser counter-UAV test method and apparatus.

To achieve the objective described above, the technical solution employed by the present disclosure is as follows: an arrayed high-energy laser counter-UAV test method includes the following steps:
Step 1: preparing a test apparatus and a UAV, where the test apparatus includes a high-energy laser array assembly, an automatic pan-tilt gimbal, a high-speed camera, an infrared camera, and a laser sight; the high-energy laser array assembly includes a carrier box and multiple high-power laser devices, the multiple high-power laser devices are arranged in the carrier box in parallel to form a laser array, the laser array is configured to emit a high-power laser beam to the UAV to ablate the UAV, the automatic pan-tilt gimbal is configured to drive the carrier box to rotate to adjust an emitting direction of the high-power laser beam, the high-speed camera is configured to take an image of a test process, the infrared camera is configured to take a heat distribution map of the UAV when ablated, and the laser sight is configured to emit aiming laser parallel to the high-power laser beam for detecting the UAV;
Step 2: conducting a laser counter-UAV test; turning on the automatic pan-tilt gimbal, the high-speed camera, the infrared camera and the laser sight, remotely controlling the UAV to fly into a test region, and when the laser sight detects the UAV, remotely controlling the laser array to emit the high-power laser beam to the UAV to ablate the UAV;
Step 3: observing an ablation process and analyzing an ablated morphology of the UAV to obtain a radius and ablation depth of a tested ablation area of the UAV;
Step 4: performing finite element simulation on the test process to obtain a radius and ablation depth of a simulated ablation area of the UAV; and
Step 5: comparing the radii and ablation depths of the simulated and tested ablation areas of the UAV, adjusting finite element simulation parameters to make a simulation result coincide with a test result, and deriving an ablation depth-time variation curve of a key point in the simulated ablation area.

Further, in Step 1, the high-energy laser array assembly further includes multiple water-cooled heat sinks, which are used for heat dissipation of the high-power laser devices.

Further, in Step 3, observing the ablation process specifically includes:
based on the image taken by the high-speed camera, recording the process of the UAV from being irradiated by the high-energy laser array to dropping, and obtaining key time parameters t_{b} and tᵤ;
where t_{b} is total time from the start of laser ablation to the start of rapid fall of the UAV, and tᵤ is time from the start of laser ablation to the start of an unbalanced state, such as rolling, tilting, and spinning, of the UAV.

Further, in Step 3, analyzing the ablated morphology of the UAV specifically includes:
analyzing the image taken by the high-speed camera, and observing whether multiple parts of the UAV are ablated and a distribution of the ablated parts;
observing a microscopic morphology of the ablated part of the UAV under an optical microscope, comparing ablation degrees of different parts, defining an area with the highest ablation degree as a core ablation area, defining other areas with low ablation degree as secondary ablation areas, and defining an area without being ablated as an intact area; and
analyzing the ablation area center and boundary morphology of each ablated part to obtain a radius and ablation depth of the ablated area of the UAV.

Further, Step 4 specifically includes:
establishing a two-dimensional geometric model of a UAV housing in COMSOL software and meshing the two-dimensional geometric model;
setting the finite element simulation parameters and inputting the parameters into a Gaussian beam algorithm in a laser spectral resonator to perform finite element simulation analysis on the ablation process; and
outputting a simulation result to obtain the radius and ablation depth of the simulated ablation area of the UAV, and deriving an ablation depth-time variation curve of a key point in the simulated ablation area.

Further, the Gaussian beam algorithm in the laser spectral resonator specifically includes:
enabling q-parameters of a Gaussian beam to pass through an optical system with a transformation matrix of

$$M = [ \begin{matrix}A & B \\ C & D\end{matrix} ] ,$$

where a transformation of the q-parameter also follows ABCD law, that is:

$${q}_{2} = \frac{A {q}_{1} + B}{C {q}_{1} + D} ;$$

$${q}_{2}^{- 1} = \frac{C + {Dq}_{1}^{- 1}}{A + {Bq}_{1}^{- 1}} ;$$

in the formula: q₁- and

$${q}_{1}^{- 1}$$

are q-parameters before transmission transformation, q₂ and

$${q}_{2}^{- 1}$$

are q-parameters after transmission transformation; if the Gaussian beam passes through an optical system with multiple optical elements, the transformation matrix M is determined by a product of various optical element transformation matrices M₁, M₂, . . . , Mₙ;
when q₁- or

$${q}_{1}^{- 1}$$

-parameter and M₁, M₂, . . . , Mₙ are known, solving for q- or q⁻¹-parameter at any position z through the ABCD law, and then performing an operation of separating real and imaginary parts based on the q- or q⁻¹-parameter to obtain an isophase surface curvature radius R(z), a spot radius w(z), a position from a beam waist, and a beam waist radius at the position;
setting that the Gaussian beam in the laser spectral resonator is represented by the q-parameters, that a round-trip transmission matrix at a cavity mirror 1 is

$$[ \begin{matrix}a & b \\ c & d\end{matrix} ] ,$$

and that the q- and q⁻¹-parameter of a resonant beam satisfy a self-reproduction condition:

$${q}^{- 1} = \frac{c + {dq}^{- 1}}{a + {bq}^{- 1}} ;$$

$$q = \frac{a q + b}{c q + d} ;$$

solving for the q⁻¹-parameter to obtain:

$${q}^{- 1} = \frac{d - a}{2 b} \pm i \frac{\sqrt{1 - {( \frac{a + d}{2} )}^{2}}}{b} , b \neq 0 ;$$

$${q}^{- 1} = \frac{c}{a - d} , b = 0 ;$$

solving for the q-parameter to obtain:

$$q = \frac{a - d}{2 c} \pm i \frac{\sqrt{1 - {( \frac{a + d}{2} )}^{2}}}{c} , c \neq 0 ;$$

$$q = \frac{b}{d - a} , c = 0 ;$$

where i is a unit matrix;
multiple solutions are present when solving for the q-parameter numerically, where a rule of choosing the solution is that a beam half-width square of the beam is positive;
separating the real and imaginary parts after solving for the q-parameter, where the real part and the imaginary part correspond to a beam waist position and a beam waist radius of the beam, respectively; and solving for beam parameters of the Gaussian beam transformed by the optical system by using the ABCD law to obtain a beam waist position and a beam waist radius of the beam after transmission transformation; and
separating the real and imaginary parts after solving for the q⁻¹-parameter, where the real part and the imaginary part correspond to an isophase surface curvature radius and a spot radius of the beam, respectively; solving for beam parameters of the Gaussian beam transformed by the optical system by using the ABCD law to obtain an isophase surface curvature radius and a spot radius of the beam after transmission transformation.

The present disclosure further provides an arrayed high-energy laser counter-UAV test apparatus, including a high-energy laser array assembly, an automatic pan-tilt gimbal, a high-speed camera, an infrared camera, and a laser sight;
the high-energy laser assembly includes a carrier box and multiple high-power laser devices, the multiple high-power laser devices are arranged in the carrier box in parallel to form a laser array, and the laser array is configured to emit a high-power laser beam to a UAV to ablate the UAV;
the automatic pan-tilt gimbal is arranged at the bottom of the carrier box and configured to drive the carrier box to rotate to adjust an emitting direction of the high-power laser beam;
the high-speed camera and the infrared camera are both arranged nearby the high-energy laser array assembly, the high-speed camera is configured to take an image of a test process, and the infrared camera is configured to take a heat distribution map of the UAV when ablated; and
the laser sight is arranged at the top of the carrier box and is configured to emit aiming laser parallel to the high-power laser beam for detecting the UAV.

Further, the arrayed high-energy laser array assembly further includes multiple water-cooled heat sinks, and each water-cooled heat sink abuts against the corresponding high-power laser device and is used for heat dissipation of the high-power laser device.

It can be learned from the foregoing description of the present disclosure that, compared with the prior art, the present disclosure has beneficial effects as follows.

1. A solution is put forward to make up for the lack of definition of a remote image tracking device. The increase of the number of high-power laser devices can achieve the strike on UAV in a wider range. Multi-point high-temperature ablation of a target UAV is achieved, and a probability of striking vulnerable parts of the UAV is increased.

2. According to the present disclosure, the mechanism of arrayed high-energy laser striking a UAV is analyzed through experiments to optimize the structure of the arrayed high-energy laser, ensuring striking efficiency while reducing cost.

3. The test method provided by the present disclosure integrates actual test and finite element simulation, which not only ensures the accuracy of the test result, but also reduces the test cost through the finite element simulation.

### BRIEF DESCRIPTION OF THE DRAWINGS

FIG. 1 is a flowchart of steps of an arrayed high-energy laser counter-UAV test method according to a preferred embodiment of the present disclosure;

FIG. 2 is a diagram of a structure of a test apparatus and a UAV according to a preferred embodiment of the present disclosure;

FIG. 3 is a diagram of a structure of a high-energy laser array assembly according to a preferred embodiment of the present disclosure.

In the drawings: 1—unmanned aerial vehicle; 2—automatic pan-tilt gimbal; 3—high-speed camera; 4—infrared camera; 5—laser sight; 6—carrier box; 7—high-power laser device; 8—water-cooled heat sink.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure.

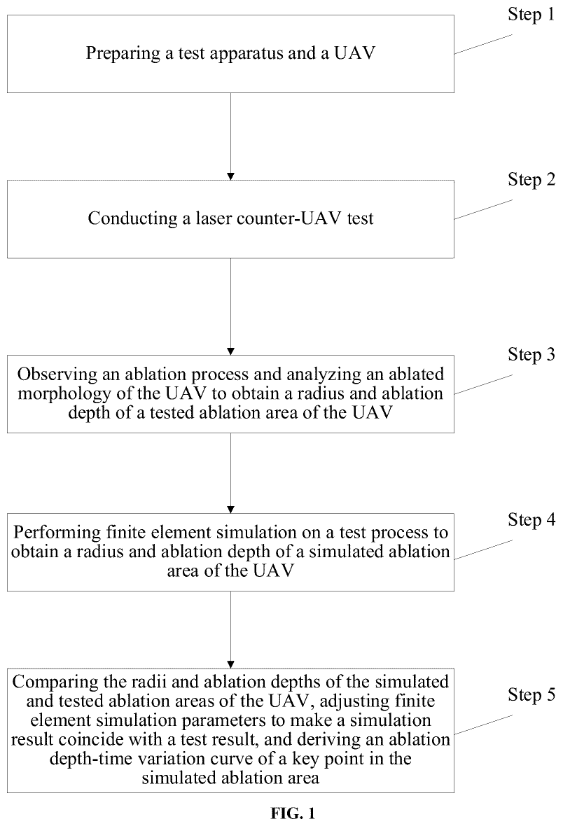

With reference to FIG. 1, an arrayed high-energy laser counter-UAV test method according to a preferred embodiment of the present disclosure includes the following steps.

Step 1: A test apparatus and a UAV 1 are prepared, where the test apparatus includes a high-energy laser array assembly, an automatic pan-tilt gimbal 2, a high-speed camera 3, an infrared camera 4, and a laser sight 5; the high-energy laser array assembly includes a carrier box 6 and multiple high-power laser devices 7, the multiple high-power laser devices 7 are arranged in the carrier box 6 in parallel to form a laser array, the laser array is configured to emit a high-power laser beam to the UAV 1 to ablate the UAV 1, the automatic pan-tilt gimbal 2 is configured to drive the carrier box 6 to rotate to adjust an emitting direction of the high-power laser beam, the high-speed camera 3 is configured to take an image of a test process, the infrared camera 4 is configured 20) to take a heat distribution map of the UAV 1 when ablated, and the laser sight 5 is configured to emit aiming laser parallel to the high-power laser beam for detecting the UAV 1.

Step 2: A laser counter-UAV test is conducted; the automatic pan-tilt gimbal 2, the high-speed camera 3, the infrared camera 4 and the laser sight 5 are turned on, the UAV is remotely controlled to fly into a test region, and when the laser sight 5 detects the UAV 1, the laser array is remotely controlled to emit the high-power laser beam to the UAV 1 to ablate the UAV 1.

Step 3: An ablation process is observed, and an ablated morphology of the UAV 1 is analyzed to obtain a radius and ablation depth of a tested ablation area of the UAV 1.

Step 4: Finite element simulation is performed on the test process to obtain a radius and ablation depth of a simulated ablation area of the UAV 1.

Step 5: The radii and ablation depths of the simulated and tested ablation areas of the UAV are compared, finite element simulation parameters are adjusted to make a simulation result coincide with a test result, and an ablation depth-time variation curve of a key point in the simulated ablation area is derived.

A solution is put forward by the present disclosure to make up for the lack of definition of a remote image tracking device. The increase of the number of high-power laser devices can achieve the strike on UAV 1 in a wider range. Multi-point high-temperature ablation of a target UAV 1 is achieved, and a probability of striking vulnerable parts of the UAV is increased. According to the present disclosure, the mechanism of arrayed high-energy laser striking the UAV 1 is analyzed through experiments to optimize the structure of the arrayed high-energy laser, ensuring striking efficiency while reducing cost. The test method provided by the present disclosure integrates actual test and finite element simulation, which not only ensures the accuracy of the test result, but also reduces the test cost through the finite element simulation.

As a preferred embodiment of the present disclosure, the following additional technical features may also be achieved.

In this embodiment, in Step 1, the high-energy laser array assembly further includes multiple water-cooled heat sinks 8. The water-cooled heat sink 8 is used for heat dissipation of the high-power laser device 7. As the high-power laser device 7 generates too much heat when operating, each high-power laser device 7 is configured with one water-cooled heat sink 8 to dissipate heat to prevent the device from burning out.

In this embodiment, in Step 3, observing the ablation process specifically includes the following steps.

Based on the image taken by the high-speed camera 3, the process of the UAV 1 from being irradiated by the high-energy laser array to dropping is recorded to obtain key time parameters t_{b} and tᵤ.

t_{b} is the total time from the start of laser ablation to the start of rapid fall of the UAV 1, and tᵤ is the time from the start of laser ablation to the start of an unbalanced state, such as rolling, tilting, and spinning, of the UAV 1.

In this embodiment, in Step 3, analyzing the ablated morphology of the UAV specifically includes the following steps.

The image taken by the high-speed camera is analyzed to observe whether multiple parts of the UAV 1 are ablated and a distribution of the ablated parts.

A microscopic morphology of the ablated part of the UAV is observed under an optical microscope, and ablation degrees of different parts are compared, where an area with the highest ablation degree is defined as a core ablation area, other areas with low ablation degree are defined as secondary ablation areas, and an area without being ablated is defined as an intact area.

The ablation area center and boundary morphology of each ablated part are analyzed to obtain a radius and ablation depth of the ablated area of the UAV 1.

In this embodiment, Step 4 specifically includes the following steps.

A two-dimensional geometric model of an UAV housing in COMSOL software is established and meshed.

The finite element simulation parameters are set, and the parameters are input into a Gaussian beam algorithm in a laser spectral resonator to perform finite element simulation analysis on the ablation process.

A simulation result is output to obtain the radius and ablation depth of the simulated ablated area of the UAV 1, and an ablation depth-time variation curve of a key point in the simulated ablation area is derived.

In this embodiment, the Gaussian beam algorithm in the laser spectral resonator specifically includes the following steps.

q-parameters of a Gaussian beam pass through an optical system with a transformation matrix of

$$M = [ \begin{matrix}A & B \\ C & D\end{matrix} ] ,$$

where a transformation of the q-parameter also follows ABCD law, that is:

$${q}_{2} = \frac{A {q}_{1} + B}{C {q}_{1} + D} ;$$

$${q}_{2}^{- 1} = \frac{C + {Dq}_{1}^{- 1}}{A + {Bq}_{1}^{- 1}} ;$$

in the formula: q₁- and

$${q}_{1}^{- 1}$$

are q-parameters before transmission transformation, q₂ and

$${q}_{2}^{- 1}$$

are q-parameters after transmission transformation; if the Gaussian beam passes through an optical system with a plurality of optical elements, the transformation matrix M is determined by a product of various optical element transformation matrices M₁, M₂, . . . , Mₙ;
when q₁- or

$${q}_{1}^{- 1}$$

-parameter and M₁, M₂, . . . , Mₙ are known, q- or q⁻¹-parameter at any position z can be solved for through the ABCD law, and then an operation of separating real and imaginary parts is performed based on the q- or q⁻¹-parameter to obtain an isophase surface curvature radius R(z), a spot radius w(z), a position from a beam waist, and a beam waist radius at the position.

It is set that the Gaussian beam in the laser spectral resonator is represented by the q-parameters, that a round-trip transmission matrix at a cavity mirror 1 is

$$[ \begin{matrix}a & b \\ c & d\end{matrix} ] ,$$

and that the q- and q⁻¹-parameter of a resonant beam satisfy a self-reproduction condition:

$${q}^{- 1} = \frac{c + {qd}^{- 1}}{a + {bq}^{- 1}} ;$$

$$q = \frac{aq + b}{cq + d} .$$

The q⁻¹-parameter is solved for to obtain:

$${q}^{- 1} = \frac{d - a}{2 b} \pm i \frac{\sqrt{1 - {( \frac{a + d}{2} )}^{2}}}{b} , b \neq 0 ;$$

$$q = \frac{c}{a - d} , b = 0 ;$$

the q-parameter is solved for to obtain:

$$q = \frac{a - d}{2 c} \pm i \frac{\sqrt{1 - {( \frac{a + d}{2} )}^{2}}}{c} , c \neq 0 ;$$

$$q = \frac{b}{d - a} , c = 0 ;$$

where i is a unit matrix.

There may be multiple solutions when solving for the q parameter numerically, where a rule of choosing the solution is that a beam half-width square of the beam should be positive.

The real and imaginary parts are separated after solving for the q-parameter, where the real part and the imaginary part correspond to a beam waist position and a beam waist radius of the beam, respectively; and beam parameters of the Gaussian beam transformed by the optical system are solved for by using the ABCD law to obtain a beam waist position and a beam waist radius of the beam after transmission transformation.

The real and imaginary parts are separated after solving for the q⁻¹-parameter, where the real part and the imaginary part correspond to an isophase surface curvature radius and a spot radius of the beam, respectively; and beam parameters of the Gaussian beam transformed by the optical system are solved for by using the ABCD law to obtain an isophase surface curvature radius and a spot radius of the beam after transmission transformation.

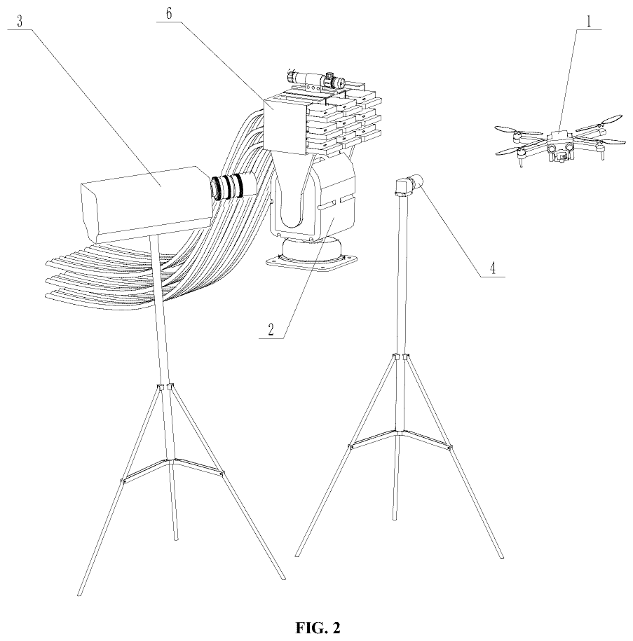

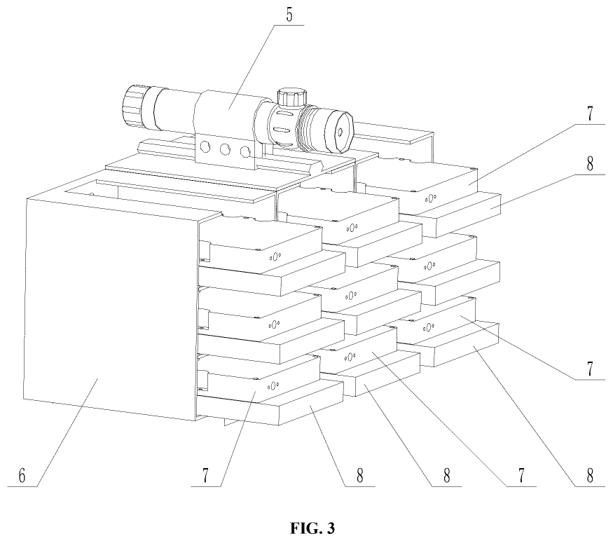

With reference to FIG. 2 to FIG. 3, the present disclosure further provides an arrayed high-energy laser counter-UAV test apparatus, including a high-energy laser array assembly, an automatic pan-tilt gimbal 2, a high-speed camera 3, an infrared camera 4, and a laser sight 5.

The high-energy laser assembly includes a carrier box 6 and multiple high-power laser devices 7, the plurality of high-power lasers 7 are arranged in the carrier box 6 in parallel to form a laser array, and the laser array is configured to emit a high-power laser beam to the UAV 1 to ablate the UAV 1.

The automatic pan-tilt gimbal 2 is arranged at the bottom of the carrier box 6 and configured to drive the carrier box to 6 rotate to adjust an emitting direction of the high-power laser beam.

The high-speed camera 3 and the infrared camera 4 are arranged nearby the high-energy laser array assembly, the high-speed camera 3 is configured to take an image of a test process, and the infrared camera 4 is configured to take a heat distribution map of the UAV 1 when ablated.

The laser sight 5 is arranged at the top of the carrier box 6 and is configured to emit aiming laser parallel to the high-power laser beam to detect the UAV 1.

In this embodiment, the high-energy laser array assembly further includes multiple water-cooled heat sinks 8, and each water-cooled heat sink 8 abuts against the corresponding high-power laser device 7 and is used for heat dissipation of the high-power laser device 7.

The foregoing is only the preferred implementation of the present disclosure, but the scope of protection of the present disclosure is not limited thereto. Replacements or changes made by any person skilled in the art based on the technical solutions of the present disclosure and improvement concepts thereof within the technical scope disclosed in the present disclosure should be covered in the scope of protection of the present disclosure.

What is claimed is:

1. An arrayed high-energy laser counter-UAV (Unmanned Aerial Vehicle) test method, comprising the following steps:
Step 1: preparing a test apparatus and a UAV, wherein the test apparatus comprises a high-energy laser array assembly, an automatic pan-tilt gimbal, a high-speed camera, an infrared camera, and a laser sight; the high-energy laser array assembly comprises a carrier box and a plurality of high-power laser devices, the plurality of high-power laser devices are arranged in the carrier box in parallel to form a laser array, the laser array is configured to emit a high-power laser beam to the UAV to ablate the UAV, the automatic pan-tilt gimbal is configured to drive the carrier box to rotate to adjust an emitting direction of the high-power laser beam, the high-speed camera is configured to take an image of a test process, the infrared camera is configured to take a heat distribution map of the UAV when ablated, and the laser sight is configured to emit aiming laser parallel to the high-power laser beam for detecting the UAV;
Step 2: conducting a laser counter-UAV test; turning on the automatic pan-tilt gimbal, the high-speed camera, the infrared camera and the laser sight, remotely controlling the UAV to fly into a test region, and when the laser sight detects the UAV, remotely controlling the laser array to emit the high-power laser beam to the UAV to ablate the UAV;
Step 3: observing an ablation process and analyzing an ablated morphology of the UAV to obtain a radius and ablation depth of a tested ablation area of the UAV;
Step 4: performing finite element simulation on the test process to obtain a radius and ablation depth of a simulated ablation area of the UAV; and
Step 5: comparing the radii and ablation depths of the simulated and tested ablation areas of the UAV, adjusting finite element simulation parameters to make a simulation result coincide with a test result, and deriving an ablation depth-time variation curve of a key point in the simulated ablation area;
wherein Step 4 specifically comprises:
establishing a two-dimensional geometric model of a UAV housing in COMSOL software and meshing the two-dimensional geometric model;
setting the finite element simulation parameters and inputting the parameters into a Gaussian beam algorithm in a laser spectral resonator to perform finite element simulation analysis on the ablation process; and
outputting a simulation result to obtain the radius and ablation depth of the simulated ablation area of the UAV, and deriving an ablation depth-time variation curve of a key point in the simulated ablation area;
the Gaussian beam algorithm in the laser spectral resonator specifically comprises:
enabling q-parameters of a Gaussian beam to pass through an optical system with a transformation matrix of
$$M = [ \begin{matrix}A & B \\ C & D\end{matrix} ] ,$$
wherein a transformation of the q-parameter also follows ABCD law, that is:
$${q}_{2} = \frac{{Aq}_{1} + B}{{Cq}_{1} + D} ;$$
$${q}_{2}^{- 1} = \frac{C + {Dq}_{1}^{- 1}}{A + {Bq}_{1}^{- 1}} ;$$
in the formula: q₁- and
$${q}_{1}^{- 1}$$
are q-parameters before transmission transformation, q₂ and
$${q}_{2}^{- 1}$$
are q-parameters after transmission transformation; if the Gaussian beam passes through an optical system with a plurality of optical elements, the transformation matrix M is determined by a product of various optical element transformation matrices M₁, M₂, . . . , Mₙ;
when q₁- or
$${q}_{1}^{- 1}$$
-parameter and M₁, M₂, . . . , Mₙ are known, solving q- or q⁻¹-parameter at any position z through the ABCD law, and then performing an operation of separating real and imaginary parts based on the q- or q⁻¹-parameter to obtain an isophase surface curvature radius R(z), a spot radius w(z), a position from a beam waist, and a beam waist radius at the position;
setting that the Gaussian beam in the laser spectral resonator is represented by the q-parameters, that a round-trip transmission matrix at a cavity mirror 1 is
$$[ \begin{matrix}a & b \\ c & d\end{matrix} ] ,$$
and that the q- and q⁻¹-parameter of a resonant beam satisfy a self-reproduction condition:
$${q}^{- 1} = \frac{c + {dq}^{- 1}}{a + {bq}^{- 1}} ;$$
$$q = \frac{aq + b}{cq + d} ;$$
solving for the q⁻¹-parameter to obtain:
$${q}^{- 1} = \frac{d - a}{2 b} \pm i \frac{\sqrt{1 - {( \frac{a + d}{2} )}^{2}}}{b} , b \neq 0 ;$$
$${q}^{- 1} = \frac{c}{a - d} , b = 0 ;$$
solving for the q-parameter to obtain:
$$q = \frac{a - d}{2 c} \pm i \frac{\sqrt{1 - {( \frac{a + d}{2} )}^{2}}}{c} , c \neq 0 ;$$
$$q = \frac{b}{d - a} , c = 0 ;$$
wherein i is a unit matrix;
a plurality of solutions are present when solving for the q-parameter numerically, wherein a rule of choosing the solution is that a beam half-width square of the beam is positive;
separating the real and imaginary parts after solving for the q-parameter, wherein the real part and the imaginary part correspond to a beam waist position and a beam waist radius of the beam, respectively; and solving for beam parameters of the Gaussian beam transformed by the optical system by using the ABCD law to obtain a beam waist position and a beam waist radius of the beam after transmission transformation; and
separating the real and imaginary parts after solving for the q⁻¹-parameter, wherein the real part and the imaginary part correspond to an isophase surface curvature radius and a spot radius of the beam, respectively; solving for beam parameters of the Gaussian beam transformed by the optical system by using the ABCD law to obtain an isophase surface curvature radius and a spot radius of the beam after transmission transformation.

2. The arrayed high-energy laser counter-UAV test method according to claim 1, wherein in Step 1, the high-energy laser array assembly further comprises a plurality of water-cooled heat sinks, which are used for heat dissipation of the high-power laser devices.

3. The arrayed high-energy laser counter-UAV test method according to claim 1, wherein in Step 3, observing the ablation process specifically comprises:
based on the image taken by the high-speed camera, recording the process of the UAV from being irradiated by the high-energy laser array to dropping, and obtaining key time parameters t_{b} and tᵤ;
wherein t_{b} is total time from the start of laser ablation to the start of rapid fall of the UAV, and tᵤ is time from the start of laser ablation to the start of an unbalanced state, such as rolling, tilting, and spinning, of the UAV.

4. The arrayed high-energy laser counter-UAV test method according to claim 1, wherein in Step 3, analyzing the ablated morphology of the UAV specifically comprises:
analyzing the image taken by the high-speed camera, and observing whether a plurality of parts of the UAV are ablated and a distribution of the ablated parts;
observing a microscopic morphology of the ablated part of the UAV under an optical microscope, comparing ablation degrees of different parts, defining an area with the highest ablation degree as a core ablation area, defining other areas with low ablation degree as secondary ablation areas, and defining an area without being ablated as an intact area; and
analyzing the ablation area center and boundary morphology of each ablated part to obtain a radius and ablation depth of the ablated area of the UAV.

5. An arrayed high-energy laser counter-UAV test apparatus, wherein the apparatus is used for performing the arrayed high-energy laser counter-UAV test method according to claim 1 and comprises a high-energy laser array assembly, an automatic pan-tilt gimbal, a high-speed camera, an infrared camera, and a laser sight;
the high-energy laser assembly comprises a carrier box and a plurality of high-power laser devices, the plurality of high-power laser devices are arranged in the carrier box in parallel to form a laser array, and the laser array is configured to emit a high-power laser beam to a UAV to ablate the UAV;
the automatic pan-tilt gimbal is arranged at the bottom of the carrier box and configured to drive the carrier box to rotate to adjust an emitting direction of the high-power laser beam;
the high-speed camera and the infrared camera are both arranged nearby the high-energy laser array assembly, the high-speed camera is configured to take an image of a test process, and the infrared camera is configured to take a heat distribution map of the UAV when ablated; and
the laser sight is arranged at the top of the carrier box and is configured to emit aiming laser parallel to the high-power laser beam for detecting the UAV.

6. The arrayed high-energy laser counter-UAV test apparatus according to claim 5, wherein the high-energy laser array assembly further comprises a plurality of water-cooled heat sinks, and each water-cooled heat sink abuts against the corresponding high-power laser device and is used for heat dissipation of the high-power laser device.
